(19) United States
(12) Patent Application Publication
(10) Pub. No.: US 2026/0366745 A1
(43) Pub. Date: Nov. 19, 2026

(54) ENVIRONMENTALLY SUSTAINABLE SYSTEMS AND METHODS OF OUTDOOR EXTRACTION OF AIR VENTED OUT FROM INDOOR SOLAR CAVITY

(71) Applicants: Alfa Sustainable Projects Ltd., Kfar Vitkin (IL); Alumeshet Ltd, Yavne (IL)

(72) Inventors: Chen SHALITA, Kfar Vitkin (IL); Jerome Sebbag, Natanyia (IL); Hillel Setton, Kiriat Yaarim (IL)

(73) Assignees: Alfa Sustainable Projects Ltd., Kfar Vitkin (IL); Alumeshet Ltd, Yavne (IL)

(21) Appl. No.: 19/674,186

(22) Filed: May 12, 2026

(30) Foreign Application Priority Data
May 14, 2025 (IL) 320887

(51) Int. Cl. F24F 7/06; E06B 9/42; E06B 9/68; E06B 9/70; E06B 9/72; F24F 7/00; F24F 11/00; F24F 11/76; G01K 3/14

(52) U.S. Cl. CPC F24F 7/065; E06B 9/42; E06B 9/70; E06B 9/72; F24F 11/0001; F24F 11/76; G01K 3/14; E06B 2009/6809; F24F 2007/001

(57) ABSTRACT

An environmentally sustainable method and system for outdoor extraction of heated air from an indoor solar cavity are described; the method and system include an exterior facade covered at least partially by transparent and/or translucent glazing, a controllable blinds system having at least one elongated opaque solar blinds screen windable on at least one rotatable drum mounted inwardly offset from the facade to form the indoor solar cavity between the glazing and the blinds screen, a suspended ceiling forming a subceiling space, a collection trough isolated from indoor building air and positioned above the rotatable drum with a downwardly oriented elongated inlet opening, an airway connecting the indoor solar cavity to the collection trough, and an outdoor extraction system including at least one inlet, a collector conduit, a blower fan, and an exterior outlet configured to actively extract heated air from the indoor solar cavity and discharge the heated air outside the building; the system may operate in summer and/or winter modes by selective deployment of the blinds screen from top and/or bottom rotatable drums to control airflow and thermal management, may isolate extracted air from air-conditioning circulation airflows, may control blower airflow according to temperature differentials, and may be configured for retrofitting existing facade systems.

### CROSS REFERENCE TO RELATED APPLICATIONS

This application claims priority of Israel Patent Application No. 320887, filed on May 14, 2025, the entire contents of which are incorporated herein by reference.

### TECHNICAL FIELD

In general, the present invention pertains to the art of thermodynamics, HVAC and functional aspects of building construction, while reducing material resource and carbon dioxide emissions. In particular, the invention relates to environmentally sustainable systems and methods of effectively venting out and/or evacuating air, from an indoor solar cavity, formed in-between a facade of a glazed building and interior blinds and/or awning screen, followed by active extraction of the vented air to outside of the building, as well as various implementation modes and setups thereof.

### BACKGROUND ART

It is believed that the current state of the art is represented by the following patent literature: DE19626354.

DE19626354 that is believed to represent the closest prior art discloses a shade comprising two sets of polarizing flat components which are movable between overlapping and fully-covering positions. In DE19626354, one of the sets of components (3) extends over a large number of windows (5) in the facade. In DE19626354, one or more sets of components can extend over the entire area of the facade, and the components can be parallel to each other and also to the facade. In DE19626354, those in one set can be parallel to the facade, while those in the other are inclined to it. In DE19626354, relative movement can be such as to allow overlapping of components with different directions of polarity.

The ACT Facade describes a system designed for modern fully glazed office buildings, aiming to enhance indoor comfort while reducing cooling energy demands. It combines insulated exterior glazing, an internal sun-shading blind, and mechanical ventilation. Solar radiation is absorbed on the blind's surface and the resulting heat is vented out through a ventilated cavity between the glazing and the blind using extract air from the office, preventing interior overheating.

ACT Facade concept presented by Priedemann is available at https://web.archive.org/web/20250117160011/https://priedemann. net/en/services/facade-lab/act-facade.html

### SUMMARY OF THE INVENTION

The following summary of the invention is provided to exhibit the basic understanding of some principles, underlying various aspects and features of the invention. This summary is not an extensive overview of the invention and as such it is not necessarily intended to particularly identify all key or critical elements of the invention and is not to delineate the scope of the invention. Its sole purpose is to present some concepts of the invention in a simplified form as a prelude to the following more detailed.

The invention was made in view of the deficiencies of the prior art and provides systems, methods and processes for overcoming these deficiencies. According to some embodiments and aspects of the present invention, there is provided an environmentally sustainable method of outdoor extraction of an air vented out from an indoor solar cavity; the method includes: forming an indoor solar cavity including: providing an exterior facade of a building, in which at least a substantial portion of the facade is covered by a transparent and/or translucent glazing; providing a controllable blinds system comprising: at least one elongated solar blinds screen made essentially of an opaque and/or perforated material; a rotatable drum, connected to the at least one elongated solar blinds screen, configured for winding and unwinding the at least one elongated solar blinds screen, in which the rotatable drum is mounted in a top portion of the indoor solar cavity and/or a bottom portion of the indoor solar cavity; a driving mechanism operationally coupled to the cylinder, configured for controllably rotating the rotatable drum; mounting the rotatable drum of the controllable blinds system inwardly offset the facade, thereby forming the indoor solar cavity, in-between the at least one elongated solar blinds screen and the glazing.

In some embodiments, a suspended ceiling forms a subceiling space in the building, where a collection trough is installed; characterized by that: the collection trough being substantially isolated from the air inside the building; the collection trough is installed essentially above the rotatable drum of the controllable blinds system; the collection trough including an elongated inlet opening and an outlet; the elongated inlet opening of the collection trough is oriented essentially downwards.

In some embodiments, an airway is formed between the top portion of the indoor solar cavity and the elongated inlet opening of the collection trough, in which an interior lumen of the indoor solar cavity forms a continuum with an interior lumen the collection trough.

In some embodiments, an outdoor extraction system configured to actively extract the air from the building includes: at least one inlet configured for intake of the air from inside of the building; a collector conduit operationally connected to the at least one inlet, configured to collect the from the inlet; a blower fan operationally connected to the collector conduit, configured to actively conduct the air; an exterior outlet, operationally connected to the blower fan, configured to discharge the air to outside of the building.

In some embodiments, an operational connection is formed between the outlet of the collection trough and the at least one inlet of the outdoor extraction system.

In some embodiments, the blower fan of the outdoor extraction system is configured to extract the air from the indoor solar cavity, via the airway, and the collection trough and the collector conduit, to outside of the building.

According to some embodiments and aspects of the present invention, there is provided an environmentally sustainable system for outdoor extraction of an air vented out from an indoor solar cavity, the system comprises: an indoor solar cavity comprising: an exterior facade of a building, in which at least a substantial portion of the facade is covered by a transparent and/or translucent glazing; a controllable blinds system comprising: at least one elongated solar blinds screen made essentially of an opaque material; a rotatable drum, connected to the at least one elongated solar blinds screen, configured for winding and unwinding the at least one elongated solar blinds screen, in which the rotatable drum is mounted in a top portion of the indoor solar cavity and/or a bottom portion of the indoor solar cavity; a driving mechanism operationally coupled to the cylinder, configured for controllably rotating the rotatable drum; in which the rotatable drum of the controllable blinds system is mounted inwardly offset the facade, thereby forming the indoor solar cavity, in-between the at least one elongated solar blinds screen and the glazing.

In some embodiments, an operational connection between the outlet of the collection trough and the at least one inlet of the outdoor extraction system is formed; in which the blower fan of the outdoor extraction system is configured to extract the air from the indoor solar cavity, via the airway, the collection trough and the collector conduit, to outside of the building. In some embodiments, an operational connection between the outlet of the collection trough and a damper located in the exterior glazing through which air is exhausted is formed.

According to some embodiments and aspects of the present invention, there is provided an environmentally sustainable method of interior recirculating of warmed air vented out from an indoor solar cavity, the method including: forming an indoor solar cavity including: providing an exterior facade of a building, wherein at least a substantial portion of the facade is covered by a transparent and/or translucent glazing; providing a controllable blinds system including: at least one elongated solar blinds screen made essentially of an opaque material; a rotatable drum, connected to the at least one elongated solar blinds screen, configured for winding and unwinding the at least one elongated solar blinds screen, wherein the rotatable drum is mounted at a bottom portion of the indoor solar cavity; a driving mechanism operationally coupled to the rotatable drum, configured for controllably rotating the rotatable drum; mounting the rotatable drum of the controllable blinds system inwardly offset the facade, thereby forming the indoor solar cavity, in-between the at least one elongated solar blinds screen and the glazing.

According to some embodiments and aspects of the present invention, there is provided an environmentally sustainable system for interior recirculating of warmed air vented out from an indoor solar cavity, the system including: an indoor solar cavity including: an exterior facade of a building, wherein at least a substantial portion of the facade is covered by a transparent and/or translucent glazing; a controllable blinds system including: at least one elongated solar blinds screen made essentially of an opaque material; a rotatable drum, connected to the at least one elongated solar blinds screen, configured for winding and unwinding the at least one elongated solar blinds screen; characterized by that the rotatable drum is mounted at a bottom portion of the indoor solar cavity; a driving mechanism operationally coupled to the cylinder, configured for controllably rotating the rotatable drum; wherein the rotatable drum of the controllable blinds system is mounted inwardly offset the facade, thereby forming the indoor solar cavity, in-between the at least one elongated solar blinds screen and the glazing.

### DEFINITIONS

The term matching or a term similar thereto, as referred to herein, is to be construed as having a cross-sectional area and/or shape of a component equal or essentially similar to a cross-sectional area and/or shape of another component. It should be acknowledged that the components may only to be similar in the cross-sectional areas and/or shapes, to satisfy the term matching or similar, so long as the cross-sectional areas of the components can be mated and/or inserted into each other and/or the combination thereof essentially fits together and/or occupy essentially the same space.

The term structured, as referred to herein, is to be construed as including any geometrical shape, exceeding in complexity a plain linear shape or a shape embodying a simple and/or standardized circular, elliptical or polygonal contour or profile. Any more complex shape than a plain linear shape or a shape embodying a simple and/or standardized circular, elliptical or polygonal contour or profile, constitutes an example of structured geometry.

The term modular, as referred to herein, should be construed as a including a stand-alone and/or autonomically functioning of structured unit. The term modular inter alia means a standardized unit that may be conveniently installed or deployed without significant impact to the environment. The term modular, however, doesn't necessarily mean providing for ease of interchange or replacement. The term modular is optionally satisfied solely by providing for ease of onetime deployment or installation.

The terms connected, coupled, connectable and/or “in connection with” refer to any form of interaction between two or more entities, including mechanical, electrical, magnetic, electromagnetic, fluid, and thermal interactions. Components can be operatively coupled to each other even though they are not in direct contact with each other. The term “abutting” refers to items that are in direct physical contact with one another, although the items do not necessarily have to be attached to one another.

By operationally connected and operably coupled or similar terms used herein is meant connected in a specific way (e.g., in a manner allowing fluid to move and/or electric power or signal to be transmitted) that allows the disclosed system and its various components to operate effectively in the manner described herein.

The term readily connectable, as referred to herein, should be construed as including any structure and/or member that is configured to be conveniently connected to other structure and/or member and/or components of a larger system or assembly. The term readily connectable, however, doesn't necessarily mean readily disconnectable or removable. The term readily connectable is optionally satisfied by providing for ease of onetime connection or coupling.

The term fastener or a term similar thereto, as referred to herein, is to be construed as any suitable structure, material and/or device that effects an attachment, mounting and/or affixing, in a non-limiting manner including the examples of: bolts, screws, staples, pins, clips, magnetic couplings, zippers, snaps, magnets, non-permanent adhesives, adhesives, welding, nails, rivets, buckles, straps, stings, knots, hook and loop fasteners such as VELCRO®, which is a trademark registered to Velcro Industries B.V.

The term/s door and/or window, as referred to herein, is/are to be used interchangeably and broadly construed as any closing element of an opening, whether stationary or movable back and forth between an open position and a closed position. Along with standard doors and/or windows, the term/s door and/or window in a non-limiting manner also include/s: flaps, hatches, covers, vitrines and the like.

The term environmentally sustainable, as referred to herein, is to be construed as including any material that is biodegradable or comprising a naturally occurring and/or excavated and/or mined material, whether in original, natural or processed form. The term environmentally sustainable, as referred to herein, is to be equally construed as including in a non-limiting manner any method or technique facilitating a reduction in: (1) energy consumption including energy consumption, whether required for manufacture, storage and/or transportation, (2) the volume or mass of disposed materials, waste or emissions, as well as (3) toxicity or non-biodegradability of disposed materials, waste or emissions.

The term fluid or liquid, as referred to herein, is to be construed as any material that deforms when a shear stress is applied. While fluid generally would refer to any liquids or gases, it may be used herein to describe fluidized solids and bulk solids and/or granulate matter that are capable of flowing or otherwise moving inside a device as a result of pressure differences and/or gravitational force. Such materials may include slurries, suspensions, pastes, powders, granular solids, particle solids, granulate matter, particulate matter, as well as any combinations thereof.

The terms pliable or pliant, as referred to herein, are to be construed as having high tensile strength and capable of being efficiently elastically flexed or bent but not being resilient and incapable of being efficiently stretched or expanded. The term tensile or tensile strength, as referred to herein, is to be construed inter alia as a shortcut of the known term ultimate tensile strength, frequently represented acronym as UTS, meaning an intensive property of a material or structure to withstand loads tending to elongate, namely to resist tension, defined as the maximum stress that a material can withstand while been stretched or pulled before sustaining breaking, substantial deformation and/or necking before fracture, such as nylon, relating to essentially non-ductile materials, having UTS value ranging between about 600 and 1000 MPa or more, but not including rigid, firm or stiff materials.

The terms method and process as used herein are to be construed as including any sequence of steps or constituent actions, regardless a specific timeline for the performance thereof. The particular steps or constituent actions of any given method or process are not necessarily in the order they are presented in the claims, description or flowcharts in the drawings, unless the context clearly dictates otherwise. Any particular step or constituent action included in a given method or process may precede or follow any other particular step or constituent action in such method or process, unless the context clearly dictates otherwise. Any particular step or constituent action and/or a combination thereof in any method or process may be performed iteratively, before or after any other particular step or action in such method or process, unless the context clearly dictates otherwise. Moreover, some steps or constituent actions and/or a combination thereof may be combined, performed together, performed concomitantly and/or simultaneously and/or in parallel, unless the context clearly dictates otherwise. Moreover, some steps or constituent actions and/or a combination thereof in any given method or process may be skipped, omitted, spared and/or opted out, unless the context clearly dictates otherwise.

In the specification or claims herein, any term signifying an action or operation, such as: a verb, whether in base form or any tense, gerund or present/past participle, is not to be construed as necessarily to be actually performed but rather in a constructive manner, namely as to be performed merely optionally or potentially.

The term substantially as used herein is a broad term, and is to be given its ordinary and customary meaning to a person of ordinary skill in the art (and is not to be limited to a special or customized meaning), and refers without limitation to being largely but not necessarily entirely of that quantity or quality which is specified.

The term essentially means that the composition, method or structure may include additional ingredients, stages and or parts, but only if the additional ingredients, the stages and/or the parts do not materially alter the basic and new characteristics of the composition, method or structure claimed.

As used herein, the term essentially changes a specific meaning, meaning an interval of plus or minus ten percent (±10%). For any embodiments disclosed herein, any disclosure of a particular value, in some alternative embodiments, is to be understood as disclosing an interval approximately or about equal to that particular value (i.e., ±10%).

As used herein, the terms about or approximately modify a particular value, by referring to a range equal to the particular value, plus or minus twenty percent (+/−20%). For any of the embodiments, disclosed herein, any disclosure of a particular value, can, in various alternate embodiments, also be understood as a disclosure of a range equal to about that particular value (i.e. +/−20%).

As used herein, the term or is an inclusive or operator, equivalent to the term and/or, unless the context clearly dictates otherwise; whereas the term and as used herein is also the alternative operator equivalent to the term and/or, unless the context clearly dictates otherwise.

It should be understood, however, that neither the briefly synopsized summary nor particular definitions hereinabove are not to limit interpretation of the invention to the specific forms and examples but rather on the contrary are to cover all modifications, equivalents and alternatives falling within the scope of the invention.

### DESCRIPTION OF THE DRAWINGS

The present invention will be understood and appreciated more comprehensively from the following detailed description taken in conjunction with the appended drawings in which:

FIG. 1 is a schematic diagram of an environmentally sustainable system for outdoor extraction of an air vented out from an indoor solar cavity, in accordance with some embodiments of the present invention;

FIG. 2 is a schematic diagram of an environmentally sustainable system for interior recirculating of warmed air vented from an indoor solar cavity back to the indoor space, in accordance with another embodiment of the present invention;

FIG. 3 is a perspective view of a building with an environmentally sustainable system for outdoor extraction of an air vented out from an indoor solar cavity, in accordance with some embodiments of the present invention;

FIG. 4a is a perspective view of a building with an environmentally sustainable system for outdoor extraction of an air vented out from an indoor solar cavity, showing components of an indoor solar cavity and a connection with a subceiling space, in accordance with some embodiments of the present invention;

FIG. 4b is an enlarged perspective view of a controllable blinds system and an operational connection between a collection trough and an outdoor extraction system, according with some embodiments of the present invention;

FIG. 5a is a perspective view of a building with an environmentally sustainable system for outdoor extraction of an air vented out from an indoor solar cavity, showing components of an indoor solar cavity and a connection with a subceiling space, in accordance with some embodiments of the present invention;

FIG. 5b is an enlarged perspective view of a controllable blinds system and an operational connection between a collection trough and an outdoor extraction system, according with some embodiments of the present invention;

FIG. 6a is a perspective view of a building with an environmentally sustainable system for outdoor extraction of an air vented out from an indoor solar cavity, showing components of an indoor solar cavity and a connection with a subceiling space, in accordance with some embodiments of the present invention;

FIG. 6b is an enlarged perspective view of a controllable blinds system and an operational connection between a collection trough and an outdoor extraction system, according with some embodiments of the present invention;

FIG. 7 is a flowchart of an environmentally sustainable method of outdoor extraction of an air vented out from an indoor solar cavity, according to some embodiments of the present invention.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DISCLOSURE OF EMBODIMENTS

Illustrative embodiments of the invention are described below. In the interest of clarity, not all features of actual implementation are described in this specification. It should be appreciated that various features or elements described in the context of some embodiment may be interchangeable with features or elements of any other embodiment described in the specification. Moreover, it will be appreciated that for the development of any actual embodiment, numerous implementation-specific decisions must be made to achieve the developers' specific goals, such as compliance with technology-or business-related constraints, which may vary from one implementation to another, and the effort of such a development might be complex and time-consuming, but would nevertheless be a routine undertaking for those of ordinary skill in the art having the benefit of this disclosure.

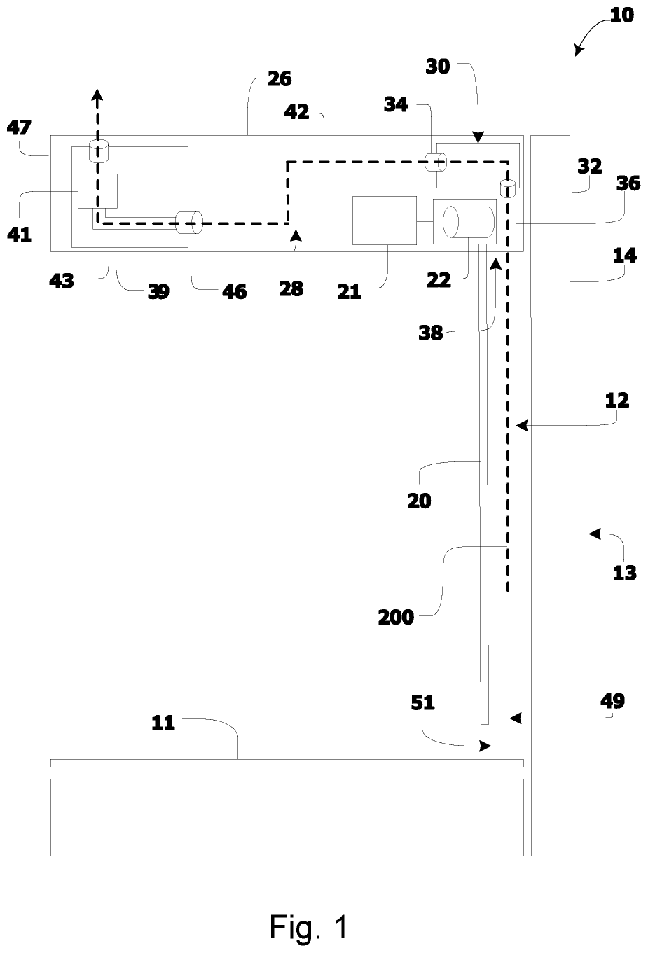

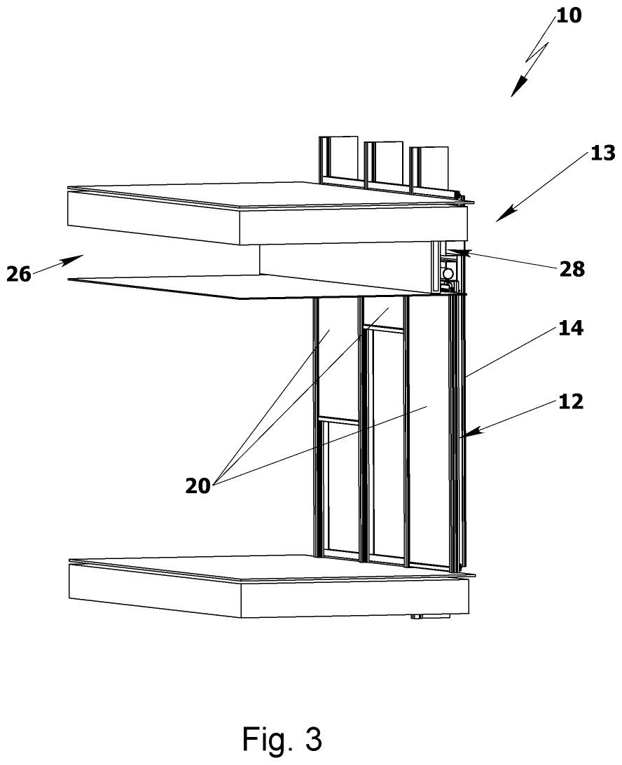

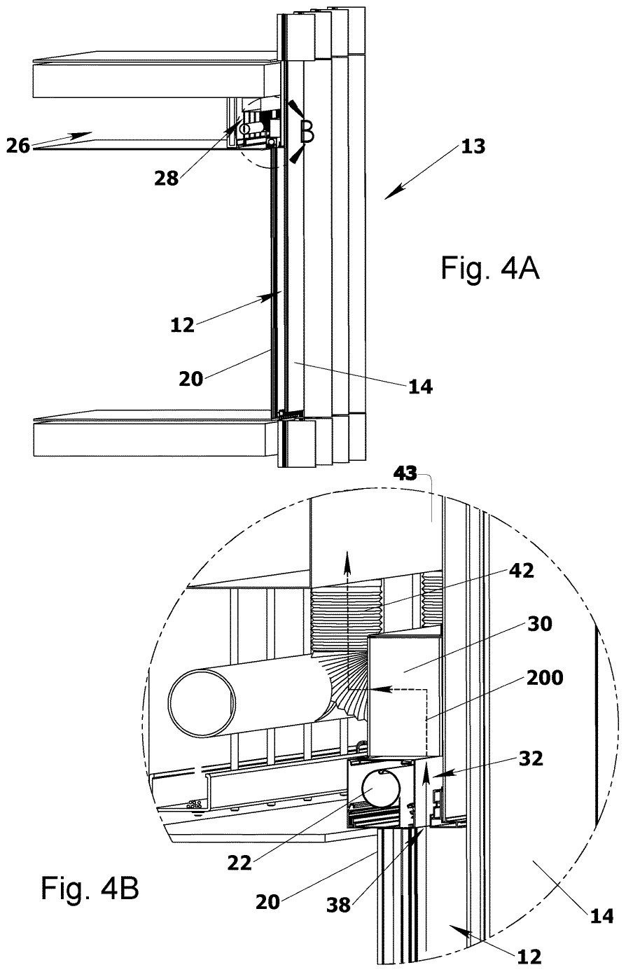

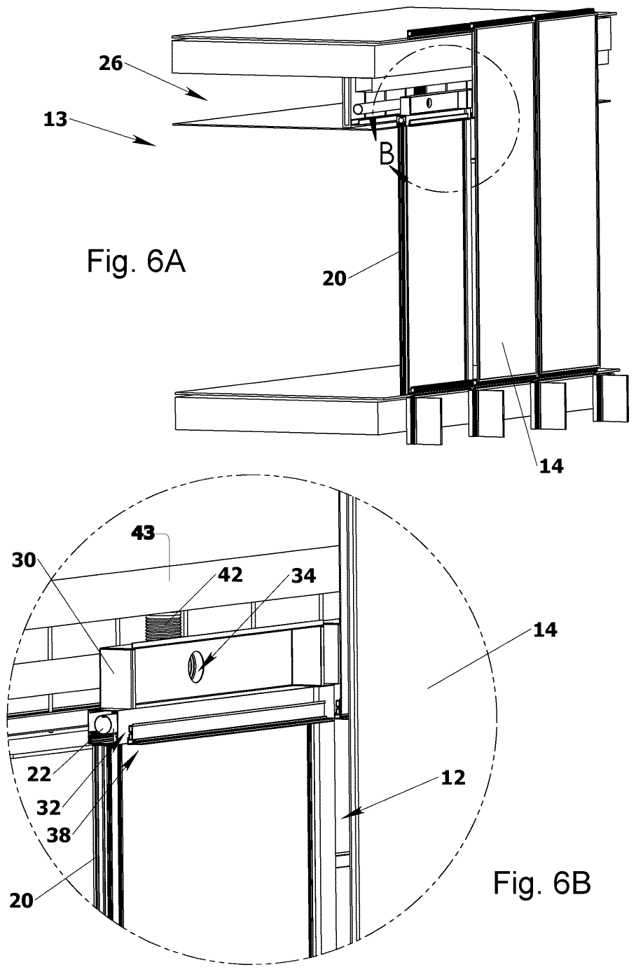

In accordance with some embodiments of the present invention, reference is now made to FIG. 1, showing a schematic diagram of environmentally sustainable system 10 for outdoor extraction of an air vented out from an indoor solar cavity, as well as to FIG. 3 to 6B showing perspective views of a building with environmentally sustainable system 10 for outdoor extraction of an air vented out from an indoor solar cavity.

In some embodiments, environmentally sustainable system 10 comprises indoor solar cavity 12. In some embodiments, indoor solar cavity 12 defines an essentially enclosed or semi-enclosed thermal zone. Indoor solar cavity 12 is configured to collect and/or accumulate solar heat, while enabling controlled air extraction.

In some embodiments, indoor solar cavity 12 comprises exterior facade 14 of building 13. In some embodiments, at least a substantial portion of facade 14 is covered by a transparent and/or translucent glazing. In some examples, the glazing is implemented using double-glazed panels, laminated safety glass, insulated glass units, allowing solar radiation to penetrate into indoor solar cavity 12.

In other examples, the glazing covering facade 14 is treated with low-emissivity coatings or selective films configured to optimize solar heat gains while limiting infrared radiation, thereby improving energy performance. In other examples, the glazing covering facade 14 incorporates tinting or shading patterns to control glare and visual comfort.

In some embodiments, indoor solar cavity 12 further comprises a controllable blinds system. The controllable blinds system comprises at least one elongated solar blinds screen 20. At least one elongated solar blinds screen 20 is made essentially of an opaque material. In some embodiments, indoor solar cavity 12 forms an inwardly facing gap 51, in-between the bottom portion of elongated solar blinds screen 20 of the controllable blinds subsystem and floor 11 of building 13, configured for intake of an air from inside of building 13.

In some examples, at least one elongated solar blinds screen 20 comprises a technical fabric screen made of fiberglass coated with PVC, configured for high durability and excellent solar heat rejection properties. In other examples, at least one elongated solar blinds screen 20 comprises metal slats, such as aluminum or steel slats. In yet other examples, at least one elongated solar blinds screen 20 is formed as a zip screen, where a fabric is tensioned and guided along side rails. In still other examples, at least one elongated solar blinds screen 20 comprises micro-perforated materials allowing partial daylight diffusion while effectively blocking solar radiation. In other yet still other examples at least one elongated solar blinds screen 20 comprises or metalized fabrics with a reflective coating on an exterior side, to maximize reflection of solar energy and/or to minimize heat absorption within indoor solar cavity 12.

In some embodiments, the controllable blinds system further comprises rotatable drum 22. Rotatable drum 22 serves as a mechanical support and winding/unwinding mechanism for elongated solar blinds screen 20. In some embodiments, rotatable drum 22 of the controllable blinds system is mounted inwardly offset facade 14, thereby forming indoor solar cavity 12, in-between at least one elongated solar blinds screen 20 and the glazing covering facade 14.

In some embodiments, rotatable drum 22 is operationally connected to at least one elongated solar blinds screen 20. Rotatable drum 22 is configured for winding and unwinding at least one elongated solar blinds screen 20. In some embodiments, rotatable drum 22 is dimensioned to accommodate a complete retraction and/or winding-on of elongated solar blinds screen 20, thereby facilitating compact storage of elongated solar blinds screen 20 when shading is not required.

In some examples, rotatable drum 22 is made from materials such as aluminum or galvanized steel, providing structural rigidity and corrosion resistance. In other examples, rotatable drum 22 is made of stainless steel, anodized aluminum, zinc-coated metals or powder-coated steel.

In some embodiments, the controllable blinds system further comprises driving mechanism 21. Driving mechanism 21 is operationally coupled to rotatable drum 22. Driving mechanism 21 is configured for controllably rotating rotatable drum 22.

In some examples, driving mechanism 21 comprises an electric motor integrated within rotatable drum 22. In other examples, driving mechanism 21 comprises an external motor coupled to rotatable drum 22 via a belt, chain, gear system and/or planetary gear, preferably providing high torque for operating larger or heavier blinds. In some embodiments, driving mechanism 21 is configured to support an automated operation based on an input from environmental sensors, configured to monitor such elements as: solar radiation, outdoors temperature and/or indoors temperature.

In some embodiments, environmentally sustainable system 10 further comprises suspended ceiling 26. Suspended ceiling 26 typically forms subceiling space 28 in building 13. In some examples, suspended ceiling 26 includes modular panels made of materials such as gypsum board, mineral fiber, metal tiles, or perforated aluminum, allowing easy access for maintenance and/or inspection.

In some embodiments, suspended ceiling 26 forms an installation space/area above the controllable blinds system and specifically above the rotatable drum 22, configured for installation of the constituents of environmentally sustainable system 10 for outdoor extraction of an air vented out from an indoor solar cavity 12. In some examples, suspended ceiling 26 supports a placement of environmental sensors such as temperature, humidity and/or solar radiation sensors, which are operationally connected to the controller of driving mechanism 21 of the controllable blinds system.

In some embodiments, environmentally sustainable system 10 further comprises collection trough 30, typically installed in subceiling space 28. In some embodiments, collection trough 30 is substantially isolated from the air inside building. Such an isolation prevents uncontrolled air mixing and ensures that the warmed air from indoor solar cavity 12 is collected to collection trough 30, thereby optimizing an energy performance and maintaining an indoor air quality.

In some examples, collection trough 30 is made of metallic materials, such as galvanized steel or aluminum. In other examples, collection trough 30 is made of composite or insulated panels, to minimize heat exchange of the air vented from indoor solar cavity 12 during transit thereof through subceiling space 28.

In some embodiments, collection trough 30 is installed essentially above rotatable drum 22 of the controllable blinds system. In some embodiments, collection trough 30 is installed to receive the air from indoor solar cavity 12. In some embodiments, collection trough 30 comprises elongated inlet opening 32 and outlet 34. In some embodiments, collection trough 30 is installed so that elongated inlet opening 32 thereof is oriented essentially downwards. In some embodiments, environmentally sustainable system 10 further comprises airway 36 between top portion 38 of indoor solar cavity 12 and elongated inlet opening 32 of collection trough 30. In some embodiments, an interior lumen of indoor solar cavity 12 forms a continuum with an interior lumen of collection trough 30.

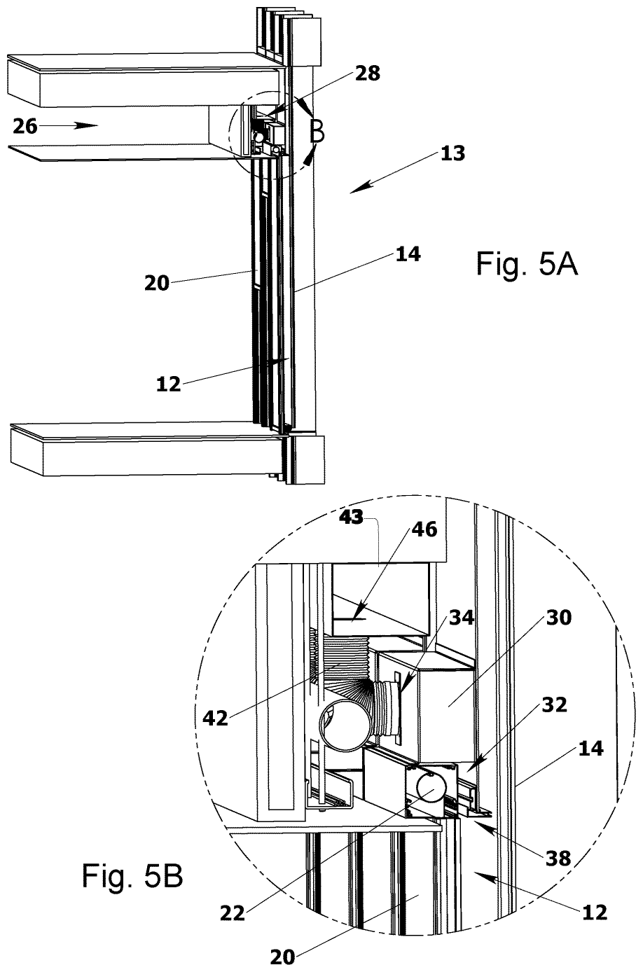

In some embodiments, such as shown in FIGS. 5A and 5B, environmentally sustainable system 10 further comprises outdoor extraction system 39. Outdoor extraction system 39 is configured to actively extract the air from collection trough 30. In some embodiments, outdoor extraction system 39 comprises collector 43. In some embodiments, collector 43 of outdoor extraction system 39 comprises at least one inlet 46. Typically, at least one inlet 46 of collector 43 of outdoor extraction system 39 is operationally connected to collection trough 30.

In some embodiments, outdoor extraction system 39 further comprises blower fan 41. Blower fan 41 is operationally connected to collector 43. Blower fan 41 is configured to actively pump the air vented out from indoor solar cavity 12, through collection trough 30 and collector 43, towards the exterior of building 13.

In some embodiments, outdoor extraction system 39 further comprises exterior outlet 47. Exterior outlet 47 is operationally connected to blower fan 41. Exterior outlet 47 is configured to discharge the air from collector 43, to outside of building 13.

In some examples, blower fan 41 comprises an inline centrifugal fan, selected for its ability to generate sufficient static pressure required to overcome ducting resistance, especially in high-rise buildings. In other examples, blower fan 44 comprises an EC (electronically commutated) motor, offering energy efficiency, variable speed control, and integration with building management systems (BMS) for dynamic airflow regulation based on real-time environmental data.

In some embodiments, environmentally sustainable system 10 further comprises an operational connection between outlet 34 of collection trough 30 and at least one inlet 46 of outdoor extraction system 39. In some embodiments, system 10 further comprises interconnecting conduit 42. Interconnecting conduit 42 is operationally connected to at least one outlet 34 of collection trough 30. Interconnecting conduit 42 is further operationally connected to at least one inlet 46 of collector 43 of outdoor extraction system 39. Interconnecting conduit 42 is configured to conduct the air to collector 43 of outdoor extraction system 39.

In some embodiments, such as shown in FIG. 1, the air heated within indoor solar cavity 12 rises through airway 36 and enters elongated inlet opening 32 of collection trough 30 in the direction of arrow 200 and/or directly to outwards of the building 13. Afterwards, in some embodiments, the air flows from outlet 34 of collection trough 30 and through interconnecting conduit 42 into at least one inlet 46 of collector 43 of outdoor extraction system 39. From collector 43 the air is ultimately discharged to outside of building 13 through exterior outlet 46.

In some embodiments, blower fan 41 of outdoor extraction system 39 is configured to extract the air from indoor solar cavity 12, via airway 36, collection trough 30 and interconnecting conduit 42, into collector 43 and then to outside of building 13. In some examples, airway 36 forms a direct path between a top portion of indoor solar cavity 12 and elongated inlet opening 32 of collection trough 30, enabling a spontaneous rise of heated air from indoor solar cavity 12 into collection trough 30 due to thermal buoyancy, for the subsequent extraction by blower fan 41.

In some embodiments, additionally to environmentally sustainable system 10 building 13 further comprises an air-conditioner system. The air-conditioner system comprises a supply inlet and a return air outlet, in which an air passing through airway 36 is essentially isolated from the air circulating between the return air outlet and the supply inlet of the air-conditioner subsystem.

In some embodiments, rotatable drum 22 of the controllable blinds system is mounted in top portion 38 of indoor solar cavity 12. In some embodiments, such as shown in FIG. 1, at least one elongated solar blinds screen 20 is configured to be deployed in a top-down direction, from rotatable drum 22 downward toward a bottom portion of indoor solar cavity 12.

In some embodiments, such as shown in FIG. 1, environmentally sustainable system 10 is configured to operate in a summer mode. During the summer mode, at least one elongated solar blinds screen 20 is configured to be deployed in a top-down direction, downwards from rotatable drum 22 and towards bottom portion 49 of indoor solar cavity 12, thereby forming gap 51, in-between at least one elongated solar blinds screen 20 and floor 11 of building 13.

In some embodiments, during the summer mode, solar radiation penetrates the transparent and/or translucent glazing covering facade 14 and warms the air within indoor solar cavity 12. The heated air spontaneously rises and directed through airway 36 into collection trough 30, for subsequent extraction to outside of building 13 by outdoor extraction system 39.

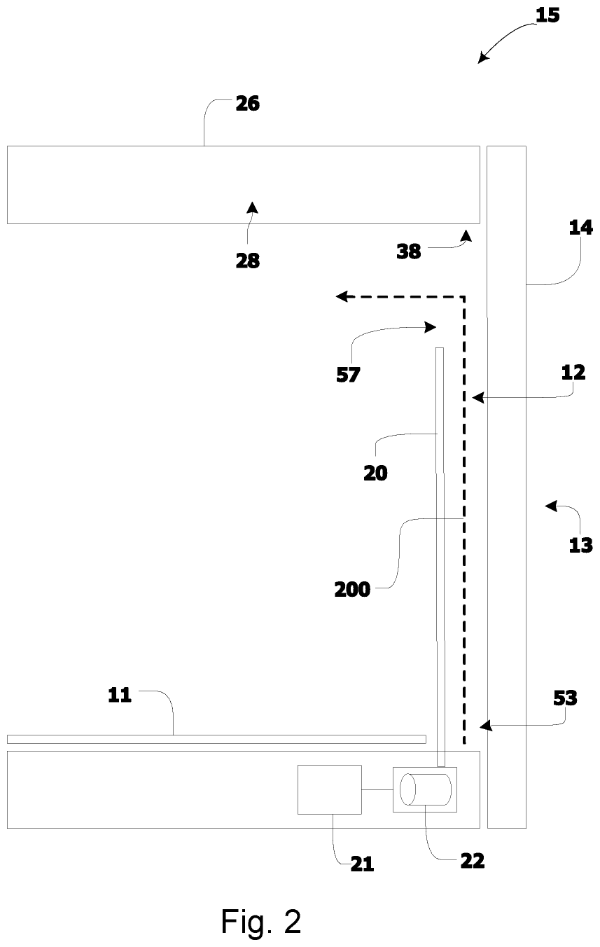

In accordance with some embodiments of the present invention, reference is now made to FIG. 2, showing a schematic diagram of environmentally sustainable system 15 for interior recirculating of warmed air vented from indoor solar cavity 12. The embodiment of system 15 for interior recirculating of warmed air is specifically configured for warming up the interior of building 13 during cold weather.

In the embodiment of system 15, shown in FIG. 2, rotatable drum 22 is mounted in bottom portion 53 of indoor solar cavity 12. At least one elongated solar blinds screen 20 is configured to be deployed in a bottom-up direction, upwardly from rotatable drum 22 and toward top portion 38 of indoor solar cavity 12. In the embodiment of system 15, shown in FIG. 2, this configuration is particularly configured for operation in a winter mode, in which at least one elongated solar blinds screen 20 is partially deployed, forming inwardly oriented gap 57 in top portion 38 of indoor solar cavity 12. In some embodiments, solar radiation transmitted through the glazing covering facade 14 heats the air inside indoor solar cavity 12. The heated air then rises and enters inside building 13 through gap 57.

In some embodiments, the environmentally sustainable system according to the present invention comprises a combination of an upper rotatable drum 22 mounted in top portion 38 of indoor solar cavity 12, such as shown in FIG. 1, with a lower rotatable drum 22 mounted in bottom portion 49 of indoor solar cavity 12, such as shown in FIG. 2. In such embodiments, at least one elongated solar blinds screen 20 is operably connected to both drums and is windable at either end thereof, depending on the selected operational mode.

In some embodiments, such as shown in FIG. 1, during the summer mode, at least one elongated solar blinds screen 20 is unwound from upper rotatable drum 22 in a top-down direction, forming lower gap 51 for intake of indoors air, into indoor solar cavity 12. The air, during the summer mode, is then vented from indoor solar cavity 12 through airway 36 into collection trough 30, to be eventually extracted by outdoor extraction system 39. In some embodiments, such as shown in FIG. 2, during the winter mode, at least one elongated solar blinds screen 20 is unwound from the lower rotatable drum in a bottom-up direction, forming upper gap 57 within indoor solar cavity 12.

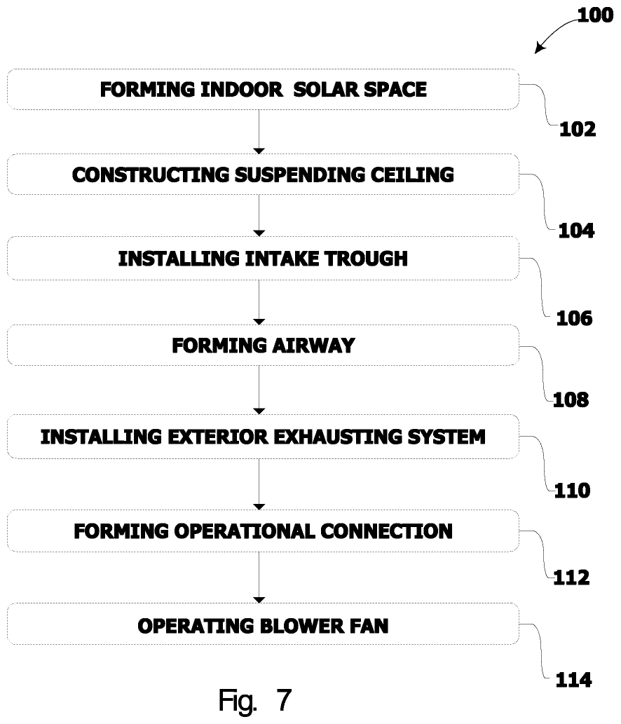

In accordance with some embodiments of the present invention, reference is now made to FIG. 7, showing flowchart 100 of an environmentally sustainable method of outdoor extraction of an air vented out from an indoor solar cavity. The method of the embodiment of FIG. 7 illustrates various features that may be interchangeable with elements of any other embodiment described in the specification.

In some embodiments, method 100 commences at step 102 of forming an indoor solar cavity. In some embodiments, step 102 comprises providing an exterior facade of a building, in which at least a substantial portion of the facade is covered by a transparent and/or translucent glazing. In some embodiments, step 102 further includes providing a controllable blinds system.

In some embodiments, step 102 comprises mounting a rotatable drum of the controllable blinds system inwardly offset the facade, thereby forming the indoor solar cavity, in-between the elongated solar blinds screen and the glazing. In some examples, step 102 includes mounting the rotatable drum of the controllable blinds system in a top portion of the indoor solar cavity. In other embodiments, step 102 includes mounting the rotatable drum of the controllable blinds system in a bottom portion of the indoor solar cavity.

In yet other examples, step 102 includes mounting the rotatable drum of the controllable blinds system in a bottom portion as well as a top portion of the indoor solar cavity. In this configuration, the at least one elongated solar blinds screen is operably connected to both, top and bottom rotatable drums and is windable at either end, depending on the selected operating mode.

In some embodiments, method 100 further comprises step 104 of constructing a suspended ceiling, thereby forming a subceiling space. In some embodiments, method 100 further comprises step 106 of installing a collection trough in the subceiling space.

In some embodiments, method 100 further comprises step 108 of forming an airway between a top portion of the indoor solar cavity and the elongated inlet opening of the collection trough, in which an interior lumen of the indoor solar cavity forming a continuum with an interior lumen the collection trough. In some embodiments, method 100 further comprises step 110 of installing an outdoor extraction system. The outdoor extraction system is configured to actively extract the air from the building.

In some embodiments, method 100 further comprises step 112 of forming an operational connection between the outlet of the collection trough and the at least one inlet of the outdoor extraction system. In some embodiments, method 100 further proceeds to step 114 of operating the blower fan of the outdoor extraction system to extract the air from the indoor solar cavity, via the airway, and the collection trough and the collector conduit, to outside of the building.

In some embodiments, method 100 comprises operating the system in a summer mode. During the summer mode, at least one elongated solar blinds screen is configured to be deployed in a top-down direction, from the rotatable drum downward toward the bottom portion of the indoor solar cavity, thereby forming a gap below at least one elongated solar blinds screen. The heated air rises spontaneously and is directed through the airway towards the collection trough for extraction by the outdoor extraction system.

In some embodiments, method 100 comprises operating the system in a winter mode. During the winter mode, the rotatable drum that is mounted in the bottom portion of the indoor solar cavity is configured to deploy the elongated solar blinds screen in a bottom-up direction, upwardly from the rotatable drum and towards the top portion of the indoor solar cavity.

In some embodiments, method 100 further comprises essentially isolating the air passing through the airway from air circulating between a return air outlet and a supply inlet of an air-conditioner system. In some embodiments, method 100 comprises controlling the driving mechanism and blower fan operation based on environmental sensor data, optimizing the system's response to varying climatic conditions and enhancing energy efficiency.

It will be appreciated by persons skilled in the art of the invention that various features and/or elements elaborated in the context of a specific embodiment described hereinabove and/or referenced herein and/or illustrated by a particular example in a certain drawing enclosed hereto, whether method, system, device or product, is/are interchangeable with features and/or elements of any other embodiment described in the specification and/or shown in the drawings. Moreover, skilled persons would appreciate that the present invention is not limited by what has been particularly shown and described hereinabove. Rather the scope of the invention is defined by the claims which follow.

1. An environmentally sustainable method of outdoor extraction of an air vented out from an indoor solar cavity, said method comprises:
(a) forming an indoor solar cavity comprising:
(I) providing an exterior facade of a building, wherein at least a portion of said facade is covered by a transparent and/or translucent glazing;
(II) providing a controllable blinds system comprising:
(i) at least one elongated solar blinds screen made of an opaque material;
(ii) a rotatable drum, connected to said at least one elongated solar blinds screen, configured for winding and unwinding said at least one elongated solar blinds screen,
wherein said rotatable drum is mounted in a position selected from the group consisting of:
a top portion of said exterior facade,
a bottom portion of said exterior facade;
(iii) a driving mechanism operationally coupled to said rotatable drum, configured for controllably rotating said rotatable drum;
(III) mounting said rotatable drum of said controllable blinds system inwardly offset said facade, thereby forming said indoor solar cavity, in-between said at least one elongated solar blinds screen and said glazing;
(b) constructing a suspended ceiling, thereby forming a subceiling space in said building;
(c) installing a collection trough in said subceiling space, characterized by that:
(I) said collection trough being isolated from said air inside said building;
(II) said collection trough is installed above said rotatable drum of said controllable blinds system;
(III) said collection trough comprising an elongated inlet opening and an outlet;
(IV) said elongated inlet opening of said collection trough is oriented downwards;
(d) forming an airway between said top portion of said indoor solar cavity and said elongated inlet opening of said collection trough, wherein an interior lumen of said indoor solar cavity forming a continuum with an interior lumen said collection trough;
(e) installing an outdoor extraction system, configured to actively extract said air from said building, said system comprising:
(I) at least one inlet configured for intake of said air from inside of said building;
(II) a collector conduit operationally connected to said at least one inlet, configured to collect said air from said inlet;
(III) a blower fan operationally connected to said collector conduit, configured to actively conduct said air;
(IV) an exterior outlet, operationally connected to said blower fan, configured to discharge said air to outside of said building;
(f) forming an operational connection between said outlet of said collection trough and said at least one inlet of said outdoor extraction system;
(g) operating said blower fan of said outdoor extraction system to extract said air from said indoor solar cavity, via said airway, and said collection trough and said collector conduit, to outside of said building.

2. The method as in claim 1, further comprises selecting said rotatable drum from at least one material selected from the group consisting of: aluminum, galvanized steel, stainless steel, anodized aluminum, zinc-coated metals, powder-coated steel.

3. The method as in claim 1, further comprises operating in a summer mode, comprising mounting said rotatable drum in said top portion of said indoor solar cavity and deploying said at least one elongated solar blinds screen in a top-down direction, thereby forming a gap in said bottom portion of said indoor solar cavity and extracting said air from said gap.

4. The method as in claim 1, further comprises operating in a winter mode, comprising mounting said rotatable drum in said bottom portion of said indoor solar cavity and partially deploying said at least one elongated solar blinds screen in a bottom-up direction, thereby forming a gap in said top portion of said indoor solar cavity and allowing said heated air to flow into said building.

5. The method as in claim 1, further comprises providing said controllable blinds system with a first rotatable drum mounted in said top portion of said indoor solar cavity and a second rotatable drum mounted in said bottom portion of said indoor solar cavity, and configuring said at least one elongated solar blinds screen for winding and unwinding from either said first or second rotatable drum.

6. The method as in claim 1, further comprises selecting a summer mode, comprising deploying said at least one elongated solar blinds screen from said first rotatable drum in a top-down direction, and a winter mode comprising deploying said at least one elongated solar blinds screen from said second rotatable drum in a bottom-up direction.

7. The method as in claim 1, further comprises isolating said air passing through said airway from air circulating between a return air outlet and a supply inlet of an air-conditioner system, thereby preventing mixing of airflows.

8. The method as in claim 1, further comprises controlling an airflow rate of said blower fan based on a measured temperature differential between said air inside said indoor solar cavity and inside of said building.

9. The method, as in claim 1, further comprises retrofitting existing facade systems by operatively connecting said indoor solar cavity to existing structural members of said building, and ventilating said indoor solar cavity between said glazing and said at least one elongated solar blinds screen.

10. An environmentally sustainable system for outdoor extraction of an air vented out from an indoor solar cavity, said system comprises:
(a) an indoor solar cavity comprising:
(I) an exterior facade of a building, wherein at least a portion of said facade is covered by a transparent and/or translucent glazing;
(II) a controllable blinds system comprising:
(i) at least one elongated solar blinds screen made of an opaque material;
(ii) a rotatable drum, connected to said at least one elongated solar blinds screen, configured for winding and unwinding said at least one elongated solar blinds screen,
wherein said rotatable drum is mounted in a position selected from the group consisting of:
a top portion of said exterior facade,
a bottom portion of said exterior facade;
(iii) a driving mechanism operationally coupled to said cylinder, configured for controllably rotating said rotatable drum;
wherein said rotatable drum of said controllable blinds system is mounted inwardly offset said facade, thereby forming said indoor solar cavity, in-between said at least one elongated solar blinds screen and said glazing;
(b) a suspended ceiling, forming a subceiling space in said building;
(c) a collection trough in said subceiling space, characterized by that:
(I) said collection trough being isolated from said air inside said building;
(II) said collection trough is installed above said rotatable drum of said controllable blinds system;
(III) said collection trough comprising an elongated inlet opening and an outlet;
(IV) said elongated inlet opening of said collection trough is oriented downwards;
(d) an airway between said top portion of said indoor solar cavity and said elongated inlet opening of said collection trough, wherein an interior lumen of said indoor solar cavity forming a continuum with an interior lumen said collection trough;
(e) an outdoor extraction system, configured to actively extract said air from said building, said system comprising:
(I) at least one inlet configured for intake of said air from inside of said building;
(II) a collector conduit operationally connected to said at least one inlet, configured to collect said air from said inlet;
(III) a blower fan operationally connected to said collector conduit, configured to actively conduct said air;
(IV) an exterior outlet, operationally connected to said blower fan, configured to discharge said air to outside of said building;
(f) an operational connection between said outlet of said collection trough and said at least one inlet of said outdoor extraction system;
wherein said blower fan of said outdoor extraction system is configured to extract said air from said indoor solar cavity, via said airway, said collection trough and said collector conduit, to outside of said building.

11. The system as in claim 10, wherein said indoor solar cavity, formed in-between said controllable blinds subsystem and a floor of said building, is configured for an air passage therein.

12. The system as in claim 10, further comprises an air-conditioner system, comprising a supply inlet and a return air outlet, wherein an air passing through said airway is isolated from an air circulating between said return air outlet and said supply inlet of said an air-conditioner subsystem.

13. The system as in claim 10, wherein said at least one elongated solar blinds screen of said controllable blinds system is selected from the group consisting of: a technical fabric screen made of fiberglass coated with PVC, metal slats, zip screen system, micro-perforated materials, and metalized fabric with a reflective coating, configured to maximize solar heat rejection and minimize heat absorption within said indoor solar cavity.

14. The system as in claim 10, wherein said driving mechanism comprises at least one electric motor selected from the group consisting of: an electric motor integrated within said rotatable drum and an external motor operationally coupled to said rotatable drum via at least one element selected from the group consisting of: a belt, chain, gear system and planetary gear.

15. The system as in claim 10, wherein said system is configured to operate in a summer mode, wherein said rotatable drum is mounted in said top portion of said indoor solar cavity and said at least one elongated solar blinds screen is configured to be deployed in a top-down direction, thereby forming an inwardly oriented gap in a bottom portion of said indoor solar cavity for air intake.

16. The system as in claim 10, wherein said system is configured to operate in a winter mode, wherein said rotatable drum is mounted in said bottom portion of said indoor solar cavity and said at least one elongated solar blinds screen is configured to be partially deployed in a bottom-up direction, thereby forming an inwardly oriented gap in said top portion of said indoor solar cavity, configured for a back air inflow into said building.

17. The system as in claim 10, wherein said controllable blinds system comprises a first rotatable drum mounted in said top portion of said indoor solar cavity and a second rotatable drum mounted in said bottom portion of said indoor solar cavity, said at least one elongated solar blinds screen being operably connected to both said first and second rotatable drums, and being configured for winding and unwinding from either said first or second rotatable drum.

18. The system as in claim 10, wherein said system is configured to operate in a summer mode by deploying said at least one elongated solar blinds screen from said first rotatable drum in a top-down direction, and in a winter mode by deploying said at least one elongated solar blinds screen from said second rotatable drum in a bottom-up direction.

19. The system as in claim 10, wherein said air passing through said airway is isolated from air circulating between a return air outlet and a supply inlet of an air-conditioner system.

20. The system as in claim 10, wherein said system is configured for retrofitting onto existing facade systems by operatively connecting said indoor solar cavity to existing structural members of said building, and ventilating said indoor solar cavity, between said glazing and said at least one elongated solar blinds screen.
